(19) United States
(12) Patent Application Publication
(10) Pub. No.: US 2009/0129731 A1
(43) Pub. Date: May 21, 2009

(54) Method for Operating a Device for Splicing Optical Waveguides

(76) Inventor: Karsten Contag, Munchen (DE)

Correspondence Address: CORNING INCORPORATED, INTELLECTUAL PROPERTY DEPARTMENT, SP-TI-3-1, CORNING, NY, 14831, US

(21) Appl. No.: 12/342,316

(22) Filed: Dec. 23, 2008

Related U.S. Application Data
(63) Continuation of application No. PCT/EP2007/056813, filed on Jun. 20, 2007.

(30) Foreign Application Priority Data
Jul. 5, 2006 (DE) DE102006031078.0

(51) Int. Cl. G02B 6/255

(52) U.S. Cl. 385/96

(57) ABSTRACT

A device for splicing optical waveguides comprises a heating unit for heating fiber ends of optical waveguides to be spliced. The optical waveguides are heated by means of the heating unit for a time period, with the heated fiber ends emitting thermal radiation. The thermal radiation is detected in the form of intensity distributions at two different times by a recording unit. Quotients which represent a measure of the splicing temperature which occurs during the splicing process can be determined from the intensity values of the detected intensity distributions. The welding current can be varied as a function of a set value of the quotient, by a comparison with the determined quotient, in order in this way to match the splicing temperature to a desired value.

### RELATED APPLICATIONS

This application is a continuation of International Application No. PCT/EP2007/056813, filed Jun. 20, 2007, which claims priority to German Application No. DE102006031078.0, filed Jul. 5, 2006, both applications being incorporated herein by reference.

### FIELD OF THE INVENTION

The disclosure relates to a method for operating a device for splicing optical waveguides, in which the splicing temperature produced during splicing can be adjusted. The disclosure also relates to a device for splicing optical waveguides, in which the splicing temperature produced during splicing can be adjusted.

### TECHNICAL BACKGROUND

When splicing optical waveguides, the fiber ends of the optical waveguides to be spliced are heated such that the fiber ends can be fused to one another. The requirements for a high-quality splicing point include the optical attenuation which the light experiences on passing through the splicing point being as low as possible. The quality of the splicing point in this case depends in particular on the splicing temperature reached during the splicing process. Furthermore, in order to achieve reproducible results during fusion splicing of optical waveguides, it is necessary to reproducibly reach a specific optical waveguide temperature during the splicing process.

The actual temperature of the optical waveguides is in general unknown, but is given indirectly by the power of the heat source which is used for splicing the optical waveguides. For example, for splicing appliances which use a glow discharge between two electrodes as a heat source, the current level flowing between the electrodes is in general the measure that is normally used for the power of the heat source. The relationship between the current level and the splicing temperature that is reached depends, however, on the one hand on environmental influences, such as the air pressure, the ambient temperature and the air humidity, while on the other hand the relationship between different splicing devices of the same type can vary as a result of component and manufacturing tolerances. It is therefore difficult to set the desired splicing temperature just by presetting a specific current level.

Since, however, the splicing temperature can in general be varied just by varying the current level which flows between the welding electrodes, a calibration process is necessary, which produces a relationship between a selected current level and power of the heat source and the splicing temperature that is reached.

Various methods are known for adjusting the splicing temperature. By way of example, the document EP 0320978 describes a method in which a bare fiber end is subjected to a heat source. In this case, the fiber end is melted and is rounded by the surface tension. In consequence, the fiber end is pulled back with respect its original position. The extent to which the fiber is shortened in this process corresponds to the power of the heat source. The thermal power can be determined approximately by measuring the fiber shortening, and can be set to a predetermined value. However, the method is inaccurate to a certain extent since the melting conditions during the calibration process differ too much from the conditions during an actual splicing process.

A similar method is disclosed in the document JP 5150132, in which the measured volume of a melted fiber end is used as a measure of the thermal power. The document EP 0934542 describes a method in which a fiber section is subjected to a defined tensile force, while at the same time being heated by arc pulses of a specific current level and duration. In consequence, the fiber section is narrowed. The narrowing is then measured and is compared with a predetermined set value of the narrowing. The current level of the pulses or their duration, and thus the power of the heat source, can be regulated by determining the discrepancy between the actual measured narrowing and the nominal value of the narrowing. However, the method is very complex since it requires the use of a defined tensile force and, in practice, an additional splicing process is required in order to produce a continuous fiber section.

Laid-open specification DE 19746080 describes a method in which two fiber ends are brought into contact with one another with a defined lateral offset. The two fiber ends are connected to one another by switching on the heat source for a defined time period. In this case, the offset between the two fiber ends is decreased because of the surface tension. The resultant offset is a measure of the power of the heat source. However, the method must be repeated a number of times in order to set a predetermined heat source power, requiring a large amount of effort in order to prepare the fiber ends. Furthermore, it is necessary to produce a splicing appliance. A similar method is described in the document U.S. Pat. No. 5,772,327. In this case, the rate at which the offset changes during heating is determined, rather than the final offset. A further similar method is disclosed in the document U.S. Pat. No. 6,294,760. In this case, two mutually offset fiber ends are heated by pulses and the change in the offset is determined after each pulse, thus allowing the thermal power to be regulated at a defined value throughout the entire process.

The document WO 03/096088 discloses a method in which an optical waveguide is subjected to a heat source, and the power of the heat source is determined on the basis of an observed reduction in the diameter of the optical waveguide. This method promises relatively good accuracy, but, for practical application, it is necessary to use current levels which are above the temperatures used during a normal splicing process, as a result of which inaccuracies can once again occur, by extrapolation.

The document U.S. Pat. No. 5,909,527 specifies a method in which a current level is determined by using different current levels to heat two fiber ends, with the intensity emitted from the fiber end in each case being measured. The current levels which are used for this purpose are less than the current levels used during the splicing process. A relationship between the current level and the intensity is determined from the recorded data, and the desired current level during a splicing process is extrapolated using this relationship. However, the method makes use of absolute intensity values, which could vary between different appliances, because of component and manufacturing tolerances. A set intensity value must therefore be determined separately for each appliance when using this method. On the other hand, current levels are also used in this case which differ from the current levels during the splicing process, as a result of which extrapolation is necessary, which can lead to the inaccuracies.

### SUMMARY

One aspect of the disclosure is directed to a method for operating a device for splicing optical waveguides, in which the splicing temperature which occurs during a splicing process can be set in a reliable manner. A further aspect of the disclosure is directed to a device for splicing optical waveguides in which the splicing temperature which occurs during the splicing process can be set in an accurate manner.

The method for operating a device for splicing optical waveguides provides for the provision of a heating unit for heating at least one optical waveguide, a recording unit for recording an intensity of thermal radiation which is emitted from the at least one heated optical waveguide, and an evaluation unit for evaluating the recorded intensity of the thermal radiation. The at least one optical waveguide is arranged in the longitudinal direction in a holding device. The heating unit is activated in order to heat the at least one optical waveguide. Intensity values of thermal radiation which is emitted from the at least one heated optical waveguide along a first lateral direction transversely with respect to the longitudinal direction and are associated with at least one intensity distribution are recorded by means of the recording unit. At least one quotient is determined from the intensity values. The heat to be emitted from the heating unit is controlled as a function of the at least one determined quotient.

According to one development of the method, a first intensity distribution of thermal radiation which is emitted from the at least one heated optical waveguide in the first lateral direction is recorded by means of the recording unit at a first time after activating the heating unit. A first intensity value is determined from the first intensity distribution at a first position along the first lateral direction of the at least one heated optical waveguide. A second intensity distribution of thermal radiation which is emitted from the at least one heated optical waveguide along the first lateral direction is recorded by means of the recording unit at a second time after recording the first intensity distribution. A first intensity value is determined from the second intensity distribution at the first position along the first lateral direction of the at least one heated optical waveguide. A first difference is determined from the determined first intensity values by means of the evaluation unit. A quotient of the determined first difference and the first intensity value determined from the second intensity distribution is determined by means of the evaluation unit.

In another refinement of the method, a second intensity value is determined from the first intensity distribution at the first time at a second position along the first lateral direction of the at least one optical waveguide. A second intensity value is determined from the second intensity distribution at the second time at the second position in the first lateral direction of the at least one heated optical waveguide. A second difference is determined from the determined second intensity values by means of the evaluation unit. A further quotient is determined from the determined second difference and the second intensity value determined from the second intensity distribution. A mean value is determined from the quotient and the further quotient. The heat to be emitted from the heating unit is controlled as a function of the determined mean value of the quotient.

In another refinement of the method, a first intensity distribution of thermal radiation which is emitted from the at least one heated optical waveguide in the first lateral direction is recorded by means of the recording unit at a first time after activating the heating unit. A first sum of intensity values is determined from the first intensity distribution at positions between a first and a second position along the first lateral direction of the at least one heated optical waveguide. After the first intensity distribution has been recorded, a second intensity distribution of thermal radiation which is emitted from the at least one heated optical waveguide along the first lateral direction is recorded by means of the recording unit at a second time. A second sum of intensity values is determined from the second intensity distribution at the positions between the first and the second position along the first lateral direction of the at least one heated optical waveguide. A third difference is determined by means of the evaluation unit from the first and the second sum of the intensity values. A quotient is determined from the third difference and the second sum of the intensity values.

Another embodiment of the method provides that a first intensity value is determined from the at least one recorded intensity distribution at a first position along the first lateral direction of the at least one heated optical waveguide. A second intensity value is determined from the at least one recorded intensity distribution at a second position along the first lateral direction of the at least one heated optical waveguide. A third intensity value is determined from the at least one recorded intensity distribution at a third position along the first lateral direction of the at least one heated optical waveguide. A sum is determined from the first and the second intensity value. A quotient is determined from the sum of the first and the second intensity value and the third intensity value.

Also disclosed is a device for splicing optical waveguides that includes a heating unit for heating at least one optical waveguide and a recording unit for recording intensity values of thermal radiation which is emitted from the at least one heated optical waveguide and is associated with at least one intensity distribution. The device may further includes an evaluation unit for evaluating the intensity values of the at least one recorded intensity distribution. The evaluation unit is designed such that it determines at least one quotient from the intensity values. The device may also further include a control unit for controlling the heat produced by the heating unit. The control unit is in this case designed such that it controls the heat to be emitted from the heating unit in order to heat the at least one optical waveguide, as a function of the at least one quotient.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operation of the invention.

### BRIEF DESCRIPTION OF THE FIGURES

FIG. 1 shows one embodiment of a device for splicing optical waveguides, in which the splicing temperature that occurs during a splicing process can be set in an accurate manner;

FIG. 2 shows one embodiment of a device for splicing optical waveguides, by means of which the intensity of thermal radiation emitted from an optical waveguide can be recorded;

FIG. 3 shows an intensity distribution of thermal radiation emitted from an optical waveguide;

FIG. 4 shows an optical waveguide in a longitudinal direction, with an area in which an intensity distribution of thermal radiation emitted from the optical waveguide is recorded;

FIG. 5 shows an intensity distribution of thermal radiation emitted from an optical waveguide, at two different times;

FIG. 6 shows a further intensity distribution of thermal radiation emitted from an optical waveguide; and

FIG. 7 shows a scatter of quotients of intensity values and different welding current levels.

### DETAILED DESCRIPTION OF THE INVENTION

Reference will now be made in detail to the preferred embodiments of the present invention, examples of which are illustrated in the accompanying drawings. Whenever possible, like reference numbers will be used to refer to like components or parts.

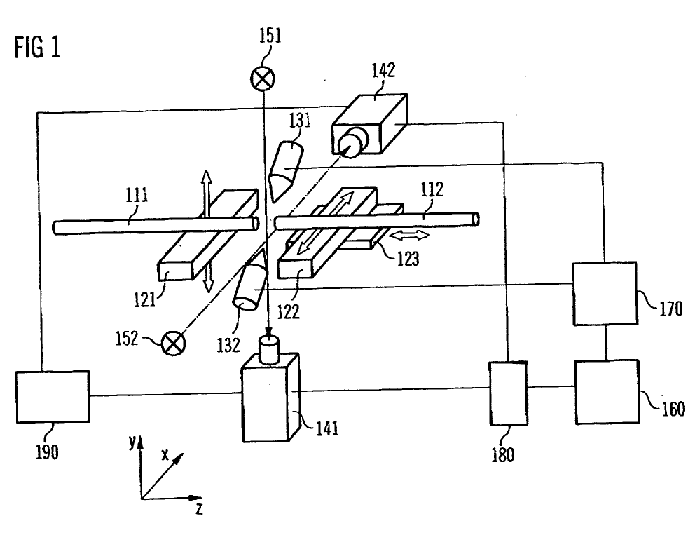

FIG. 1 shows a device for splicing optical waveguides 111 and 112. The optical waveguide 111 is arranged in a holding device 121 in a longitudinal direction z of the optical waveguide. The holding device 121 can be moved in a lateral direction y transversely with respect to the longitudinal direction z. The optical waveguide 112 is arranged in a holding device 122 in a longitudinal direction z of the optical waveguide. The holding device 122 can be moved in a lateral direction x transversely with respect to the longitudinal direction z. The holding device 122 is mounted on a movement device 123, by means of which the optical waveguide 112 can be moved in its longitudinal direction z. The optical waveguides are aligned with respect to one another, before a splicing process, by means of the moveable holding devices 121, 122 and 123.

A heating unit which comprises the two electrodes 131 and 132 is provided for splicing the two optical waveguides. Instead of the two electrodes, the heating unit may also be in the form of an incandescent filament or an incandescent wire. First of all, the end surfaces of the two optical waveguides are connected by means of the holding devices 121, 122 and 123. The heating unit is activated by a control unit 170. An arc is struck between the two electrodes 131 and 132 of the heating unit in order to heat the fiber ends of the two optical waveguides 111 and 112. This results in the two optical waveguides being fused to one another.

One measure of the quality of the splicing point is the optical attenuation which the light experiences on passing through the splicing point. The quality of the splicing point is in this case dependent in particular on the splicing temperature at which the fiber ends have been heated by the heating unit during the splicing process.

The temperature to which the fiber ends of the two optical waveguides are heated by the arc discharge between the electrodes can be varied by means of the welding current which occurs between the two electrodes. However, since the splicing temperature depends on environmental influences such as the air pressure, the ambient temperature and the air humidity, it is in general impossible to set the splicing temperature precisely by presetting a specific welding current. It should also be remembered that the splicing temperature can vary, despite the welding current being set to the same level, in different splicing appliances of the same type, as a result of component and manufacturing tolerances.

The light sources 151 and 152 as well as the associated recording systems 141 and 142 are provided in order to observe the alignment process of the two optical waveguides. The two light sources 151 and 152 are switched on in order to observe an alignment process of the two optical waveguides. The recording units 141 and 142 record images at the junction point of the two optical waveguides, which images can be displayed to a user via a display unit, which is not illustrated in FIG. 1. It is likewise possible to use the recording unit to observe the optical waveguides during the splicing process. For this purpose, the two light sources 151 and 152 are switched off, and the thermal radiation of the heated fiber ends is recorded from two different directions, by means of the recording units 141 and 142, respectively.

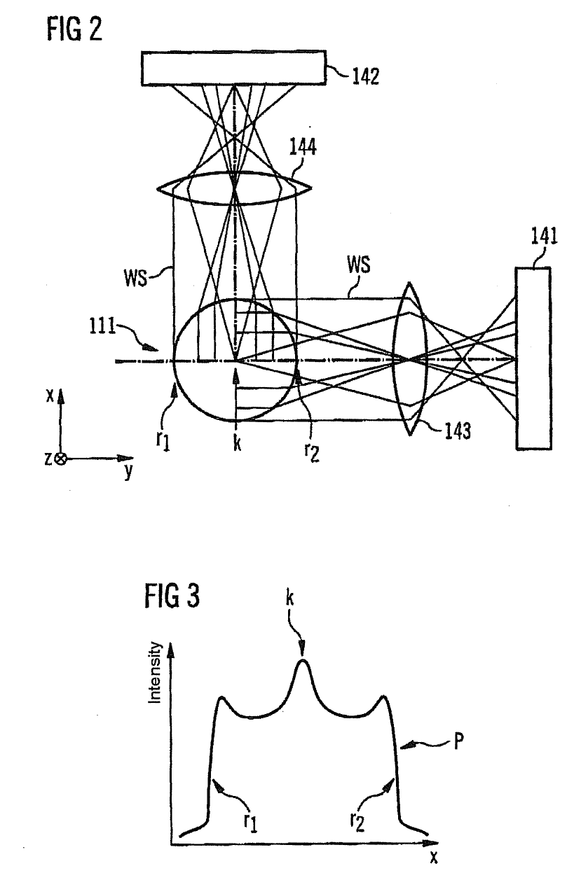

FIG. 2 shows a schematic illustration in the form of a cross section through the optical waveguide 111 as well as the observation systems which are arranged in mutually orthogonal directions and comprise the recording unit 141 and the upstream lens 143, as well as the recording unit 142, which is arranged at right angles thereto, and the upstream lens 144. The recording units 141 and 142 may, for example be in the form of cameras. Once the optical waveguide 111 has been heated by the arc discharge between the electrodes 131 and 132, thermal radiation WS is emitted, and is recorded both by the recording unit 141 and by the recording unit 142.

FIG. 3 shows an intensity distribution P which was recorded by the recording unit 141 in the lateral direction x. As can be seen in FIG. 3, the maximum is produced in the center of the distribution by the radiation from the heated fiber core. This has a different material composition than that of the fiber sheath. The fiber sheath was normally composed of pure quartz glass, and the fiber core of GeO2-doped quartz glass. In consequence, the temperature-dependent spectral distribution of the emission of thermal radiation from the fiber core and from the fiber sheath is different. As can be seen in FIG. 3, the fiber core in general emits more radiation in the visible wavelength range than the fiber sheath when heated. The intensity of the emitted spectral distribution of the thermal radiation is temperature-dependent both for the fiber core and for the fiber sheath, and can therefore be used to determine the fiber temperature, and therefore the power of the heat source.

And the fiber end of the optical waveguide 111 is heated by the heating unit for a defined time period. The thermal power in this case corresponds approximately to the power required for splicing, with the heating time duration of about 100 ms to 500 ms being shorter than the splicing duration of several seconds than is normally used. The fiber end which has been heated in this way emits thermal radiation, inter alia also in the visible wavelength range. An image of the heated fiber end is recorded by the recording unit 141 at each of two specific times t1 and t2 after activating the heating unit. For this purpose, the recording units 141 and 142 are activated by a time control unit at the two times t1 and t2 in order to record an intensity distribution of the heat intensity emitted from the optical waveguide. The heating unit is then switched off. The observation direction from which the recording unit 141 records the intensity is normally chosen to be at right angles to the fiber longitudinal axis z.

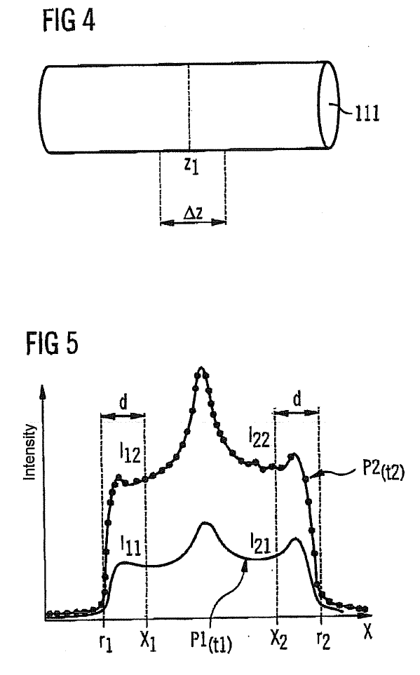

FIG. 4 shows the fiber end of the optical waveguide 111, illustrated enlarged. A first intensity profile is recorded at a time t1, and a second intensity profile is recorded at a time t2, over the entire cross section in the lateral direction x, at a defined position Z1 in the fiber longitudinal direction, which is located at a distance of approximately 20 to 200 μm from the heated fiber end.

FIG. 5 shows an intensity distribution P1 which was recorded by the recording unit 141 over the entire cross section of the optical waveguide in the x-direction at the time t1 approximately 200 ms after switching on the heating unit. The intensity distribution P2 was recorded by the recording unit 141 at the time t2, which is approximately 140 ms after the time t1. The two intensity distributions P1 and P2 are stored in a memory unit 180.

An evaluation unit 160 is provided in order to evaluate the intensity distribution stored in the memory unit 180. The evaluation unit 160 evaluates an intensity value I11 at a defined position X1 in the x-direction at right angles to the fiber longitudinal axis. An intensity value I12 is likewise determined by the evaluation unit 160 at the same position X1 in the second intensity distribution P2. The position X1 is in this case located at a defined distance d from the fiber edge r1 of the optical waveguide. The distance d may in this case be defined either in units of the camera used, that is to say for example in pixels when using a CCD camera, that is to say also relative to the diameter of the fiber in the recorded image.

A quotient Q1 which represents a measure of the temperature rise Δt (T1, T2) between the two times t1 and t2 is determined from the intensity values I11 and I12 determined in this way. The quotient Q1 is determined by means of the evaluation unit 160 to be Q1=(I12−I11)/I12. The formation of a quotient eliminates factors which link the measured intensity to the actual intensity. For example, the determined quotient is therefore independent of the sensitivity of the camera being used, which may vary between different splicing appliances.

In order to reduce influences of asymmetries in the recorded intensity distribution of the measurement, further intensity values I21 and I22 are likewise determined by the evaluation unit 160 and, preferably at a second position X2 which is likewise located at a distance d from the fiber edge r2. By way of example, asymmetries can occur in the recorded intensity distribution when the heated optical waveguide is not located on the optical axis of the imaging system. In addition to the quotient Q1 the evaluation unit 160 can therefore determine a quotient Q2=(I22−I21)/I22. The evaluation unit 160 preferably determines a mean value Qm of the two quotients Q1 and Q2, to be Qm=(Q1+Q2)/2.

A further possible way to determine a quotient of intensity values which represents a measure of the splicing temperature is to determine the sum of intensity values between the positions X1 and X2 in the intensity distribution P1 and in the intensity distribution P2. The sum of intensity values of the intensity distribution P2 is then subtracted from the sum of the intensity values of the intensity distribution P1 and is subtracted by means of the sum of intensity values between the positions X1 and X2 of the intensity distribution P2. This therefore results in a quotient Q−(ΣIP2−ΣIP1)/ΣIP2.

The time profile of the temperature during heating of the optical waveguide 111 is given, to a first approximation, by an exponential function as T(t)=TS−(TS−T0)exp(−kt). TS in this case indicates the temperature which occurs in thermal equilibrium and corresponds to the temperature during welding of the fibers. T0 is the temperature of the cold fiber and k represents a constant which depends on the heat transferred between the optical waveguide and its environment. The temperature difference ΔT (t1, t2) between the two times t1 and t2 is therefore given by ΔT (t1, t2)=T(t2)−T(t1)=(TS−T0) [exp(−kt1)−exp(−kt2)]. If the influence of the initial temperature T0 is ignored, the temperature difference ΔT(t1, t2) determined between the two defined times t1 and t2 and for which the quotients Q1, Q2 and Qm are a measure. It is therefore at the same time a measure of the splicing temperature TS, and therefore a measure of the power of the heating unit. The splicing temperature on heating of the optical waveguide is thus deduced via the determined quotient Q.

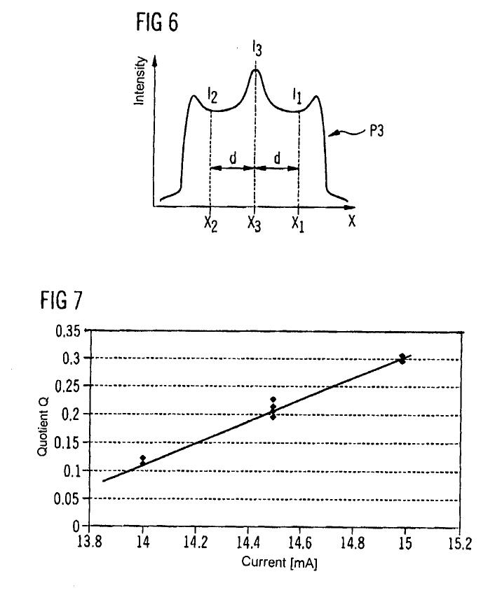

FIG. 6 shows one possible way to determine a quotient Q3, for which only a single intensity distribution at a specific time after activating the heating unit is stored in the memory unit 180. According to the invention, the maximum intensity I3 as well as the associated position X3, which is located approximately at the center of the intensity profile P3, are first of all determined by the evaluation unit 160 from the stored intensity distribution P3. The intensity I1 is determined by the evaluation unit 160 at a position X1, which is located at a defined distance d from the position X3. The distance d is in this case defined such that the intensity value I1 corresponds essentially to the intensity of radiation emitted from the fiber sheath. The distance d can also be defined either fixed in units of the camera being used, that is to say for example in pixels, or else can be defined relative to the diameter of the fiber in the recorded image. In order to reduce influences of asymmetries in the recorded intensity distribution P3 on the measurement, the intensity value I2 is determined in a further position X2 which is likewise located at the distance d from the position X1. A quotient Q3 which represents a direct measure of the splicing temperature TS of the fiber at the time at which the image is recorded, is determined from the intensity values determined in this way. The quotient Q3 is determined by the evaluation unit 160 to be Q3=(I1+I2)/2I3.

If the influence of the initial temperature T0 in the formula quoted above for the time profile of the temperature on heating of an optical waveguide is ignored, then the temperature Tt determined at a defined time t is once again a measure of the splicing temperature TS, and therefore of the power of the heat source. The splicing temperature TS can therefore also be deduced by determining the quotient Q3.

FIG. 7 shows determined quotients Q as a function of a splicing current for a splicing appliance with an arc discharge, in which case the images were recorded at the times t1=60 ms and t2=130 ms. A splicing current level of 14.5 mA in this case corresponds to a typical value for welding 1-mode fibers. This clearly shows the dependency of the quotient Q on the power of the heater unit. Since the scatter of the quotients Q for a predetermined splicing current is only low, a compensation curve can be placed through the determined quotients Q. A compensation curve such as this represents a calibration function, on the basis of which the power of the heating unit can be adapted. To this end, the control unit 170, to which the quotients Q1, Q2, Qm, Q and Q3 are supplied from the evaluation unit 160, determines at difference between these quotients and a set value QS of the quotient. On the basis of the calibration function in FIG. 7, a welding current can thus be determined as a function of the determined quotient Q in order in this way to match the power of the heating unit to the set value of the quotient. In this case, it may be necessary to take account of additional factors which influence the relationship between the actual power of the heating unit and the set current level. For example, for an arc discharge, the actual thermal power is not only a function of the set current but also a function of the air pressure, the ambient temperature and the air humidity.

Instead of using calibration functions, it is also possible to carry out one of the described methods for determining suitable coefficients a plurality of times, with the power of the heating unit being readjusted in each case after each occasion on which one of the quotients Q1, Q2, Qm, Q or Q3 is determined, until the determined quotient matches the set value of the quotient within a predetermined quotient tolerance interval. In order to regulate the welding current, the control unit 170 uses appropriate control signals to drive the heated unit comprising the electrodes 131 and 132.

In order to improve the signal-to-noise ratio of the measured values, it is advantageous to determine the intensity values I11, I12 and I21, I22 as well as I1, I2 and I3 not only at one specific position Z1 in the longitudinal direction of the fiber but in a range ΔZ, as is illustrated in FIG. 4, around the position Z1.

Furthermore, it is advantageous to determine intensity values which are produced essentially on the basis of thermal radiation from the fiber sheath. In this case, most 1-mode fibers can be used for calibration, which differ essentially in the composition of the fiber core, but whose sheath is normally composed of pure quartz glass. However, it is also feasible to determine the intensities in an area in which the thermal radiation originates essentially from the fiber core. In this case, either the choice of fibers which can be used for calibration is restricted, or set values of the quotient QS which are dependent on the fiber type are used.

The method can be used not only for a heating unit which is based on an arc discharge but also for other heat sources which are suitable for splicing optical waveguides. These include, for example, lasers, in particular CO₂ lasers as well as incandescent filaments and incandescent wires.

The method can furthermore be carried out not only at a fiber end but also at the same time for two fiber ends, for example the fiber ends of the optical waveguides 111 and 112 which are placed symmetrically around a position at which they will subsequently be spliced. The measured quotients can then be averaged between the two fiber ends, or the respectively greater or the respectively lesser value is used for calibration of the heating unit. This results in the advantage that the influence of any asymmetries of the heating unit on the calibration method is reduced.

The method can be carried out for a plurality of fibers at the same time, for example, that is to say it can also be used, for example, for splicing appliances for splicing fiber strips. In this case, a quotient can be determined for each individual fiber. Not only a quotient averaged over all the fibers but also the distribution of the quotients, that is to say the uniformity of the temperature distribution over all the fibers, can then be determined from this.

The images of the heated fiber end or ends can be recorded from a plurality of directions. In this context, FIG. 2, shows one example of an embodiment of a splicing appliance in which thermal radiation WS is recorded both in the direction y by a recorded unit 141 and in a direction x by a recording unit 142. This is possible since most splicing appliances are equipped with one or two recording units, such that the image of the fibers can be recorded from two different directions. In this case, quotients from two directions can be evaluated, thus improving the accuracy of the calibration method.

Restricting the heating time of the optical waveguide or waveguides to 100 ms to 500 ms has the advantage that deformation of the optical waveguide or waveguides is essentially avoided, as a result of which the optical waveguide or waveguides can then still be spliced to one another. In addition, a short heating duration avoids the dopant ions in the fiber core diffusing into the surrounding glass material. In consequence, the value of the measured quotient does not vary even when the method is carried out repeatedly at a single fiber end, with the same heating unit power. The regulation of the heating unit power with repeated measurements could therefore be carried out using a single fiber end. There is therefore no need to insert a newly prepared fiber end after each individual measurement. At the same time, it is also possible to heat the fiber end over a longer time period of up to a few seconds, that is to say for example until the fiber end has reached a temperature similar to that for a conventional splicing process. In this case, the relationship between the determined quotient and the splicing temperature is considerably more direct.

The correction value defined by the calibration for setting the splicing current of the heating unit is advantageously also used for subsequent splicing processes. For this purpose, the correction value is preferably stored in the splicing appliance, as a result of which it is available after the appliance is switched off and on. However, it is also possible to carry out the described method once again before each individual splicing process.

In comparison to most known methods, the method proposed here has the advantage that, in general, one or two prepared fiber ends need be inserted only once. It is therefore considerably quicker and less complex than other methods. Furthermore, it has the advantage that it can work for those settings of the heating source which are also used during a conventional splicing process. There is therefore no longer any need for extrapolation of the determined calibration, in a manner which is susceptible to errors. Since the heating time of the optical waveguides can also be restricted in such a way that deformation of an optical waveguide no longer occurs, the fiber ends can also be used for a subsequent splice. This avoids the additional insertion of a preferred fiber or two prepared fibers, just for the purpose of calibration. However, it is also possible to carry out the calibration once again before each individual splicing process.

In comparison to methods which are based on an offset measurement of fibers during heating, the method according to the invention has the advantage that it can also be used in splicing appliances in which it is not possible to set an offset such as this between fibers.

Although the present invention has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the present invention and are intended to be covered by the appended claims. It will also be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A method for operating a device for splicing optical waveguides, comprising the following steps:
providing a heating unit for heating at least one optical waveguide, a recording unit for recording an intensity of thermal radiation which is emitted from the at least one heated optical waveguide, and an evaluation unit for evaluating the recorded intensity of the thermal radiation;
arrangement of the at least one optical waveguide in a longitudinal direction in a holding device;
activation of the heating unit for heating the at least one optical waveguide,
recording of intensity values which are associated with at least one intensity distribution, of thermal radiation, which is emitted from the at least heated one optical waveguide along a first lateral direction transversely with respect to the longitudinal direction, by means of the recording unit;
determination of at least one quotient from the intensity values; and
control of the heat which is emitted from the heating unit, as a function of the at least one determined quotient.

2. The method of claim 1, further comprising the following steps:
recording of a first intensity distribution of thermal radiation, which is emitted from the at least one heated optical waveguide in the first lateral direction by means of the recording unit at a first time after the activation of the heating unit;
determination of a first intensity value from the first intensity distribution at a first position along the first lateral direction of the at least one heated optical waveguide;
recording of a second intensity distribution of thermal radiation, which is emitted from the at least one heated optical waveguide along the first lateral direction, by means of the recording unit at a second time after the recording of the first intensity distribution;
determination of a first intensity value from the second intensity distribution at the first position along the first lateral direction of the at least one heated optical waveguide;
determination of a first difference from the determined first intensity values by means of the evaluation unit; and
determination of a quotient from the determined first difference and the intensity value, determined from the second intensity distribution, by means of the evaluation unit.

3. The method of claim 2, further comprising the following steps:
determination of a second intensity value from the first intensity distribution at the first time at a second position along the first lateral direction of the at least one optical waveguide;
determination of a second intensity value from the second intensity distribution at the second time at the second position in the first lateral direction of the at least one heated optical waveguide;
determination of a second difference from the determined second intensity values by means of the evaluation unit;
determination of a further quotient from the determined second difference and from the second intensity value, determined from the second intensity distribution;
determination of a mean value from the quotient and the further quotient; and
control of the heat to be emitted by the heating unit as a function of the determined mean value of the quotients.

4. The method of claim 1, further comprising the following steps:
recording of a first intensity distribution of thermal radiation, which is emitted from the at least one heated optical waveguide in the first lateral direction, by means of the recording unit at a first time after the activation of the heating unit;
determination of a first sum of intensity values from the first intensity distribution at positions between a first and a second position along the first lateral direction of the at least one heated optical waveguide;
recording of a second intensity distribution of thermal radiation, which is emitted from the at least one heated optical waveguide along the first lateral direction, by means of the recording unit at a second time after the recording of the first intensity distribution;
determination of a second sum of intensity values from the second intensity distribution at the positions between the first and the second position along the first lateral direction of the at least one heated optical waveguide;
determination of a third distance from the first and the second sum of the intensity values by means of the evaluation unit; and
determination of a quotient from the third difference and the second sum of the intensity values.

5. The method of claim 1, further comprising the following steps:
determination of a first intensity value from the at least one recorded intensity distribution at a first position along the first lateral direction of the at least one heated optical waveguide;
determination of a second intensity value from the at least one recorded intensity distribution at a second position along the first lateral direction of the at least one heated optical waveguide;
determination of a third intensity value from the at least one recorded intensity distribution at a third position along the first lateral direction of the at least one heated optical waveguide;
determination of a sum from the first and the second intensity value; and
determination of the quotient from the sum of the first and the second intensity value and the third intensity value.

6. The method of claim 5, wherein the intensity values determined at the first position and the intensity values determined at the second position are produced by thermal radiation from an area of a fiber edge of the at least one heated optical waveguide.

7. The method of claim 5, wherein the intensity value determined at the third position is produced by thermal radiation from an area of the fiber core of the at least one heated optical waveguide.

8. The method of claim 7, wherein at least one intensity distribution of the thermal radiation, which is emitted from the at least one heated optical waveguide along a second lateral direction transversally with respect to the longitudinal direction, is recorded by the recording unit after the activation of the heating unit.

9. The method of claim 1, wherein the intensity values in each case represent a mean intensity value from a range around a position in the longitudinal direction of the at least one optical waveguide.

10. The method of claim 1, wherein a current which is supplied to the heating unit is varied as a function of the determined quotient, in order to vary the heat to be emitted from the heating unit.

11. The method of claim 1, wherein the at least one optical waveguide is heated by means of an arc discharge.

12. The method of claim 1, wherein the at least one optical waveguide is heated by means of a laser, an incandescent filament or an incandescent wire.

13. The method of claim 1, wherein the at least one optical waveguide is heated for a time which is chosen such that deformation of the optical waveguide is prevented.

14. The method of claim 1, wherein the determined quotient is compared with a set value of the quotient and wherein the heat to be emitted from the heating unit is varied until the determined quotient matches the set value of the quotient.

15. The method of claim 1, wherein the at least one recorded intensity distribution is stored in a memory unit.

16. A device for splicing optical waveguides, comprising:
a heating unit for heating at least one optical waveguide;
a recording unit for recording intensity values which are associated with at least one intensity distribution, of thermal radiation which is emitted from the at least one heated optical waveguide;
an evaluation unit for evaluating the intensity values of the at least one recorded intensity distribution, wherein the evaluation unit is designed such that it determines at least one quotient from the intensity values; and
a control unit for controlling the heat which is produced by the heating unit, wherein the control unit is designed such that it controls the heat to be emitted from the heating unit in order to heat the at least one optical waveguide, as a function of the at least one quotient.

17. The device of claim 16, further including a memory unit for storing the at least one recorded intensity distribution, wherein the memory unit is coupled to the recording unit; and
a time controller for activating the recording unit in order to record the at least on intensity distribution, wherein the time controller is designed such that it activates the recording unit in order to record a first intensity distribution at a first time after activation of the heating unit in order to heat the at least one optical waveguide, and activates the recording unit in order to record a second intensity distribution at a second time after the recording of the first intensity distribution, wherein the first and the second intensity distribution are stored in the memory unit.

18. The device of claim 17, further including a holding device for positioning the at least one optical waveguide in a longitudinal direction, wherein the evaluation unit is designed such that a first intensity value is determined from the first intensity distribution at a first position along a first lateral direction transversely with respect to the longitudinal direction of the at least one heated optical waveguide, wherein the evaluation unit is designed such that it determines a first intensity value from the second intensity distribution at the first position along the first lateral direction of the at least one heated optical waveguide, and the evaluation unit is designed such that it determines a first difference from the determined first intensity values and determines a quotient from the determined first difference and the first intensity value determined from the second intensity distribution, wherein the control unit is designed such that it controls the heat to be emitted from the heating unit as a function of the determined quotient.

19. The device of claim 18, wherein the evaluation unit is designed such that it determines a second intensity value in the first intensity distribution at a second position along the first lateral direction of the at least one heated optical waveguide, and the evaluation unit is designed such that it determines a second intensity value in the second intensity distribution at the second position along the first lateral direction of the at least one heated optical waveguide, and the evaluation unit is designed such that it determines a second difference from the determined second intensity values, and determines a further quotient from the determined second difference and the second intensity value determined from the second intensity distribution, and the evaluation unit is designed such that it determines a mean value from the quotient and the further quotient; and
the control unit is designed such that it controls the heat to be emitted from the heating unit as a function of the determined mean value of the quotients.

20. The device of claim 19, wherein the evaluation unit is designed such that it determines a first sum of further intensity values at positions between the first and the second position along the first lateral direction of the at least one optical waveguide from the first intensity distribution;
wherein the evaluation unit is designed such that it determines a second sum of intensity values at the further positions between the first and second position along the first lateral direction of the at least one optical waveguide, from the second intensity distribution;
wherein the evaluation unit is designed such that it determines a third difference from the first and the second sum of the further intensity values; and
wherein the evaluation unit is designed such that it determines the quotient from the third difference and the second sum.

21. The device of claim 16, wherein the evaluation unit is designed such that it determines a first intensity value from the at least one recorded intensity distribution at a first position along the first lateral direction of the at least one heated optical waveguide;
wherein the evaluation unit is designed such that it determines a second intensity value from the at least one recorded intensity distribution at a second position along the first lateral direction of the at least one heated optical waveguide;
wherein the evaluation unit is designed such that it determines a third intensity value from the at least one recorded intensity distribution at a third position along the first lateral direction of the at least one heated optical waveguide;
wherein the evaluation unit is designed such that it determines a sum from the first and the second intensity value; and
wherein the evaluation unit is designed such that it determines the quotient from the sum of the first and the second intensity value, and the third intensity value.

22. The device of claim 16, wherein the heating unit comprises at least two electrodes, with the heating unit heating the at least one optical waveguide by means of a arc discharge between the electrodes.

23. The device of claim 22, wherein the control unit is designed such that it varies the current between the electrodes of the heating unit as a function of the at least one determined quotient.

24. The device of claim 16, wherein the control unit is designed such that it compares the determined quotient with a set value of the quotient, and varies the heat to be emitted from the heating unit until the determined quotient matches the set value of the quotient.
